(19) United States
(12) Patent Application Publication
(10) Pub. No.: US 2014/0294538 A1
(43) Pub. Date: Oct. 2, 2014

(54) Sheet Stack Clamping Device

(71) Applicant: RISO KAGAKU CORPORATION, Tokyo (JP)

(72) Inventor: Takeshi KIMURA, Ibaraki (JP)

(73) Assignee: RISO KAGAKU CORPORATION, Tokyo (JP)

(21) Appl. No.: 14/217,656

(22) Filed: Mar. 18, 2014

(30) Foreign Application Priority Data
Mar. 29, 2013 (JP) 2013-071307

(51) Int. Cl. B42C 1/12

(52) U.S. Cl. CPC B42C 1/12
USPC 412/13

(57) ABSTRACT

A sheet stack clamping device includes a clamper for clamping a sheet stack composed of plural sheets stacked on a sheet tray along a stacking direction, and a controller that executes a preliminary clamping action for clamping the sheet stack temporarily by the clamper at least once before executing a main clamping action for clamping the sheet stack conclusively by the clamper. According to the sheet stack clamping device, wrinkles of sheets in the sheet stack can be restricted.

### BACKGROUND OF THE INVENTION

1. Technical Field

The present invention relates to a clamping device for clamping a stack of sheets.

2. Background Arts

A Patent Document 1 (Japanese Unexamined Patent Application Publication No. 2012-139867) discloses a binding machine for binding a booklet using its glue binding function. The glue binding function is a function for pasting glues on edges of stacked text-block sheets and then covering the stacked sheets by a cover sheet while gluing the stacked sheets with the cover sheet so as to make a booklet.

In such a binding machine, a sheet stack composed of text-block sheets stacked on a sheet tray is clamped by a clamping device. Subsequently, glue is pasted on a side of the sheet stack (i.e. edges of the text-block sheets) while clamping the sheet stack and then the sheet stack is glued with a cover sheet.

### SUMMARY OF THE INVENTION

In the binding machine as explained above, some of the text-block sheets in the sheet stack on the sheet tray may be curved upward due to air remaining between the text-block sheets before the sheet stack is clamped. If the sheet stack in which some of the text-block sheets are curved upward is clamped, glued and then covered by the cover sheet, a booklet having wrinkles in the text-block sheets will be made.

An object of the present invention is to provide a sheet stack clamping device that can restrict wrinkles of sheets in a clamped sheet stack.

An aspect of the present invention provides a sheet stack clamping device that includes a clamper for clamping a sheet stack composed of plural sheets stacked on a sheet tray along a stacking direction, and a controller that executes a preliminary clamping action for clamping the sheet stack temporarily by the clamper at least once before executing a main clamping action for clamping the sheet stack conclusively by the clamper.

According to the aspect, even in a case where the sheet stack on the sheet tray is curved upward due to air remaining between sheets in the sheet stack, the air remaining between the sheets is evacuated by the preliminary clamping action, and thereby the sheets can be appressed to each other. Therefore, winkles in the sheets can be restricted when the sheet stack is clamped by the main clamping action.

It is preferable that the controller determines the number of times of the preliminary clamping actions based on at least one of a type of sheets in the sheet stack, a size of sheets in the sheet stack, and a thickness of the sheet stack.

According to this configuration, the air remaining between the sheets in the sheet stack can be evacuated surely by the adequate numbers of times of the preliminary clamping actions according to the type of the sheets, the size of the sheets, and/or the thickness of the sheet stack.

### BRIEF DESCRIPTION OF THE DRAWINGS

FIG. 1 is a schematic configuration diagram of a binding system including a binding machine provided with a clamping device according to an embodiment;

FIG. 2 is a block diagram of the binding system;

FIG. 3 is a perspective view showing an aligning unit and a clamper of the binding machine;

FIG. 4 is a side view of a pair of upper and lower clamp members of the clamper;

FIG. 5 is a flow-chart of clamping operations of the clamping device;

FIG. 6 is a front view showing a preliminary clamping action;

FIG. 7 is another front view showing the preliminary clamping action;

FIG. 8 is yet another front view showing the preliminary clamping action; and

FIG. 9 is a side view showing an action for carrying a sheet stack out from the aligning unit.

### DESCRIPTION OF THE EMBODIMENTS

Hereinafter, an embodiment will be explained with reference to the drawings. In the drawings, an identical or equivalent component is indicated by an identical reference number. Note that the drawings show components schematically, and it should be understood that the components in the drawings are not shown precisely as they are. In addition, actual dimensions of the components and actual dimensional proportions among the components may be shown differently in the drawings.

Further, the embodiment described below is explained as an example that specifically carries out the subject matter of the present invention. In addition, materials, shapes, structures, arrangements of the components are not limited to those in the embodiment. The embodiment may be modified within the scope of the claims (e.g. arrangement of the components may be changed from the embodiment).

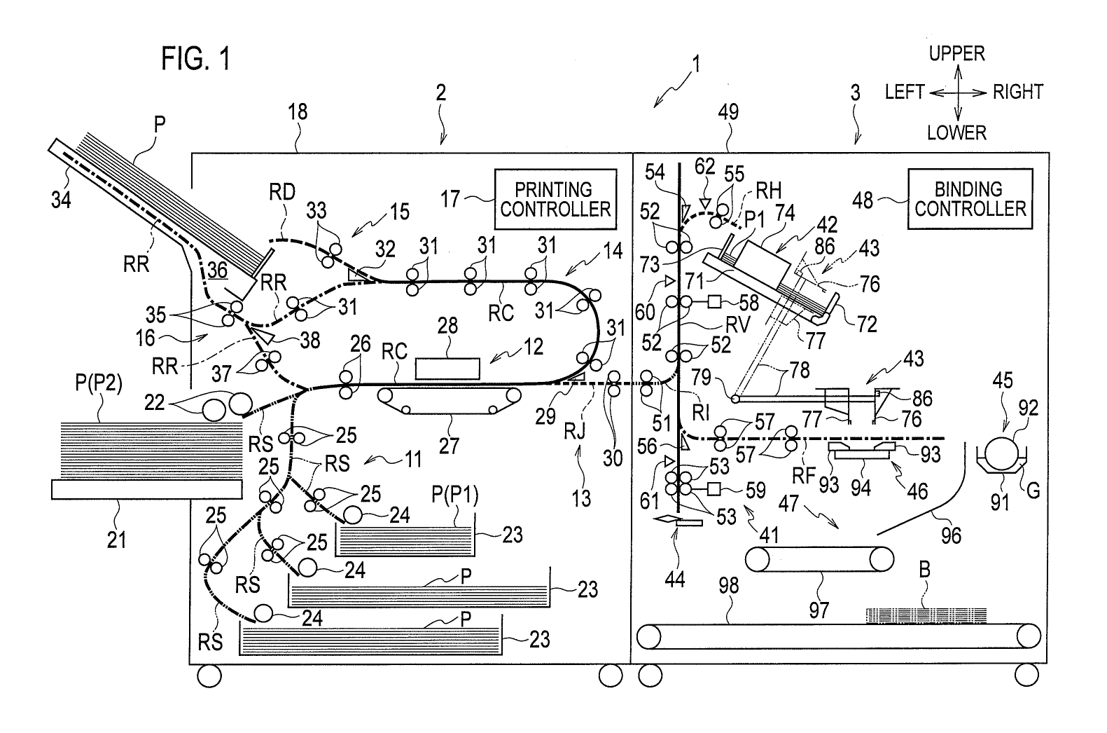

In the following explanations, your side with respect to FIG. 1 is denoted as front. A user may operate a binding system 1 shown in FIG. 1 from its front side. In addition, upper, lower, left and right are also denoted by viewing from front.

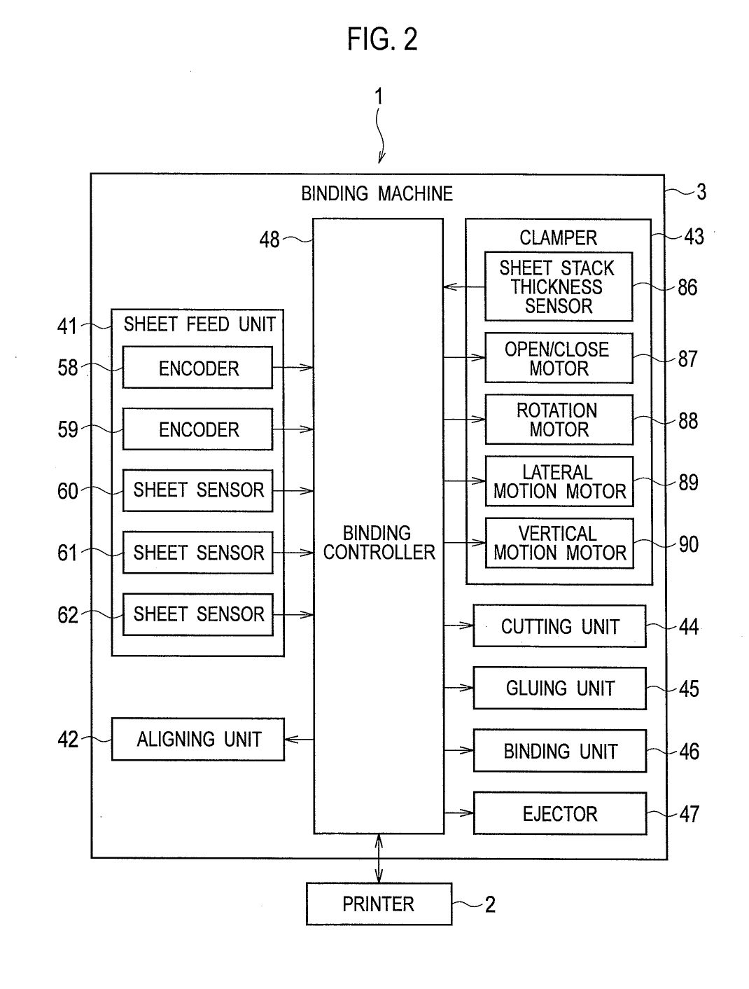

As shown in FIG. 1 and FIG. 2, the binding system 1 includes a printer 2, and a binding machine 3 that includes a clamping device according to an embodiment.

The printer 2 prints images (incl. texts) on sheets (papers) P. The printer 2 includes a sheet supply section 11, a print unit 12, a transfer section 13, a turn around section 14, an ejection section 15, a switchback section 16, a printing controller 17, and a housing 18 that houses and supports the above components.

Note that paths indicated by bold lines in FIG. 1 are feed paths along which sheets P are fed. Among the feed paths in the printer 2, a normal path RC is indicated by a solid line, a switchback path RR is indicated by a dashed one-dotted line, an ejection path RD is indicated by a dashed line, a transfer path RJ is indicated by a dotted line, and sheet supply paths RS are indicated by dashed two-dotted lines. In following explanations, terms “upstream” and “downstream” mean upstream and downstream along the feed paths.

The sheet supply section 11 supplies sheets P to the print unit 12. The sheet supply section 11 is disposed at the most upstream side along the feed paths. The sheet supply section 11 includes an external sheet supply tray 21, external sheet supply rollers 22, internal sheet supply trays (cassettes) 23, internal sheet supply rollers 24, and pairs of internal sheet supply/feed rollers 25.

On the external sheet supply tray 21, sheets P on which images are to be printed are stacked. The external sheet supply tray 21 is provided in a state where it is partially protruded out from the housing 18.

The external sheet supply rollers 22 pick up sheets P from the external sheet supply tray 21 sheet by sheet, and then feed them sequentially to a pair of after-explained registry rollers 26 along one of the sheet supply paths RS. The external sheet supply rollers 22 are disposed above the external sheet supply tray 21, and driven by a motor (not shown).

Also on the internal sheet supply trays 23, sheets P on which images are to be printed are stacked. The internal sheet supply trays 23 are disposed within the housing 18.

The internal sheet supply rollers 24 pick up sheets P from the internal sheet supply trays 23 sheet by sheet, respectively, and then feed them sequentially to the sheet supply paths RS, respectively. The internal sheet supply rollers 24 are disposed above the internal sheet supply trays 23, respectively, and driven by motors (not shown).

The pairs of internal sheet supply/feed rollers 25 sequentially feed the sheets P picked up from the internal sheet supply trays 23 to the pair of registry rollers 26. The pairs of internal sheet supply/feed rollers 25 are disposed along the sheet supply paths RS, and driven by motors (not shown).

The print unit 12 prints images on sheets P while feeding the sheets P. The print unit 12 is disposed downstream from the sheet supply section 11. The print unit 12 includes the pair of registry rollers 26, a belt feed unit 27, and an inkjet unit 28.

The pair of registry rollers 26 temporally stops the sheet P fed from the sheet supply section 11 or the switchback section 16, and then feed it to the belt feed unit 27. The pair of registry rollers 26 is disposed on the normal feed path RC nearby a confluent point of the sheet supply path RS and the switchback path RR. The pair of registry rollers 26 is driven by a motor (not shown).

The belt feed unit 27 feeds the sheet P fed from the pair of registry rollers 26 while suctioning the sheet P onto its platen belt. The belt feed unit 27 is disposed downstream from the pair of registry rollers 26. The belt feed unit 27 is driven by a motor (not shown).

The inkjet unit 28 has line-type inkjet heads (not shown) in which nozzles are aligned along a direction (back and forth direction) almost perpendicular to a sheet feed direction of the sheets P. The inkjet unit 28 is disposed above the belt feed unit 27. The inkjet unit 28 injects ink droplets from its inkjet heads to the sheet P fed by the belt feed unit 27 to print images on the sheet P.

The transfer section 13 feeds the printed sheets P to the binding machine 3 for making a booklet B. The transfer section 13 includes a switching flap 29, and a pair of transfer rollers 30.

The switching flap 29 switches over a feed path of the sheets P between the normal path RC and the transfer path RJ. The switching flap 29 is disposed nearby a branch point of the normal path RC and the transfer path RJ, and driven by a solenoid (not shown). The transfer path RJ extends from a border between the print unit 12 and the turn around section 14 toward the binding machine 3. A downstream end of the transfer path RJ is connected with an upstream end of an after-explained introduction path RI of the binding machine 3.

The pair of transfer rollers 30 feeds the sheet P fed from the belt feed unit 27 to the binding machine 3. The pair of transfer rollers 30 is disposed, on the transfer path RJ, downstream from the switching flap 29. The pair of transfer rollers 30 is driven by a motor (not shown).

The turn around section 14 feeds the sheet P fed from the belt feed unit 27 so as to turn it around from rightward to leftward. The turn around section 14 includes pairs of turn around rollers 31.

Each pair of turn around rollers 31 feeds sheets P while nipping it. The most downstream pair of turn around rollers 31 is disposed at an upstream portion of the switchback path RR. The other pairs of turn around rollers 31 are disposed from the print unit 12 to the ejection section 15 along the normal path RC. The pairs of turn around rollers 31 are driven by motors (not shown).

The ejection section 15 ejects the printed sheets P. The ejection section 15 includes a switching flap 32, a pair of ejection rollers 33, and a sheet ejection tray 34.

The switching flap 32 switches over a feed path of the sheets P between the ejection path RD and the switchback path RR. The switching flap 32 is disposed at a branch point of the ejection path RD and the switchback path RR, and driven by a solenoid (not shown).

The pair of ejection rollers 33 feeds the sheet P fed from the turn around section 14 to the sheet ejection tray 34 to eject the sheet P. The pair of ejection rollers 33 is disposed between the switching flap 32 and the sheet ejection tray 34 on the ejection path RD, and driven by a motor (not shown).

On the sheet ejection tray 34, the printed sheets P are stacked. The sheet ejection tray 34 is disposed at a downstream end of the ejection path RD.

The switchback section 16 turns over a sheet P on whose one side images are printed, and then feeds it toward the pair of registry rollers 26. The switchback section 16 includes a pair of switchback rollers 35, a switchback space 36, a pair of re-supply rollers 37, and a switching gate 38.

The pair of switchback rollers 35 feeds the sheet P fed from the turn around section 14 into the switchback space 36 temporarily, and then feeds it out from the switchback space 36 to the pair of re-supply rollers 37. The pair of switchback rollers 35 is disposed between the most downstream pair of turn around rollers 31 and a feed-in slot of the switchback space 36 on the switchback path RR, and driven by a motor (not shown).

The switchback space 36 is a space for storing the sheet P fed from the pair of switchback rollers 35 temporarily. The switchback space 36 is formed at a lower portion of the sheet ejection tray 34. The opened slot through which the sheet P is inserted into the switchback space 36 is formed nearby the pair of switchback rollers 35.

The pair of re-supply rollers 37 feeds the sheet P fed from the pair of switchback rollers 35 to the pair of registry rollers 26. The pair of re-supply rollers 37 is disposed between the pair of switchback rollers 35 and the pair of registry rollers 26 on the switchback path RR, and driven by a motor (not shown).

The switching gate 38 guides the sheet P fed from the most downstream pair of turn around rollers 31 toward the pair of switchback rollers 35. In addition, the switching gate 38 also guides the sheet P fed out from the switchback space 36 by the pair of switchback rollers 35 toward the pair of re-supply rollers 37. The switching gate 38 is disposed nearby a centroid of a triangle formed by the most downstream pair of turn around rollers 31, the pair of switchback rollers 35, and the pair of re-supply rollers 37 when viewed from front (i.e. in FIG. 1).

The printing controller 17 controls operations of the components of the printer 2. The printing controller 17 is configured to include a CPU, a RAM, a RAM, a HDD, and so on.

The binding machine 3 makes booklets B by using its glue binding function. The binding machine 3 includes a sheet feed unit 41, an aligning unit 42, a clamper 43, a cutting unit 44, a gluing unit 45, a binding unit 46, a binding controller 48, and a housing 49 that houses and supports the above components. At least the clamper 43 and the binding controller 48 are included in the sheet stack clamping device according to the present embodiment.

Here, among feed paths in the binding machine 3, a vertical feed path RV is indicated by a solid line, a text-block feed out path RH is indicated by a dotted line, a cover sheet set path RF is indicated by a dashed one-dotted line, and an introduction path RI is indicated by a dashed two-dotted line.

The sheet feed unit 41 introduces and feeds the printed text-block sheets P1 supplied from the printer 2 and the printed cover sheet P2 supplied from the printer 2. The sheet feed unit 41 includes a pair of introduction rollers 51, pairs of upper rollers 52, pairs of lower rollers 53, a switching flap 54, a pair of feed out rollers 55, a switching flap 56, pairs of horizontal feed rollers 57, encoders 58 and 59, and sheet sensors 60 to 62.

The pair of introduction rollers 51 receives the text-block sheets P1 and the cover sheet P2 from the transfer section 13 of the printer 2, and then feeds them along the introduction path RI to the vertical feed path RV. The pair of introduction rollers 51 is disposed on the introduction path RI, and driven by a motor (not shown). The upstream end of the introduction path RI is connected with the downstream end of the transfer path RJ of the printer 2.

The pairs of upper rollers 52 sequentially feed the text-block sheets P1 fed from the pair of introduction rollers 51 upward. In addition, in order to measure a size of the cover sheet P2 fed from the pair of introduction rollers 51, the pairs of upper rollers 52 feed the cover sheet P2 upward, and then reversely feed the cover sheet P2 downward after the sheet sensor 60 detects a trailing edge (lower edge) of the cover sheet P2 fed upward. The pairs of upper rollers 52 are disposed, on the vertical feed path RV, nearby a confluent point of the introduction path RI and the vertical feed path RV and nearby a branch point of the vertical feed path RV and the text-block feed out path RH. The pairs of upper rollers 52 are driven by motors (not shown).

The pairs of lower rollers 53 feed the cover sheet P2 fed from the pairs of upper rollers 52 downward to the cutting unit 44, and then reversely feed the cover sheet P2 upward after the cover sheet P2 is cut by the cutting unit 44. The pairs of lower rollers 53 are disposed, on the vertical feed path RV, under a branch point of the vertical feed path RV and the cover sheet path RF, and driven by motors (not shown).

The switching flap 54 switches over a path of the text-block sheets P1 between the vertical feed path RV and the text-block sheet feed out path RH. The switching flap 54 is disposed nearby a branch point of the vertical feed path RV and the text-block sheet feed out path RH, and driven by a solenoid (not shown).

Then, the pair of feed out rollers 55 is fed out the text-block sheets P1 fed from the pairs of upper rollers 52 to the aligning unit 42. The pair of feed out rollers 55 is disposed on the text-block sheet feed out path RH, and driven by a motor (not shown).

The switching flap 56 switches over a path of the cover sheet P2 between the vertical feed path RV and the cover sheet set path RF. The switching flap 56 is disposed nearby a branch point of the vertical feed path RV and the cover sheet set path RF, and driven by a solenoid (not shown).

The pairs of horizontal feed rollers 57 feed the cover sheet P2 fed into the cover sheet set path RF by the switching flap 56 to the binding unit 46. The pairs of horizontal feed rollers 57 are disposed along the cover sheet set path RF, and driven by motors (not shown). The downstream (right in FIG. 1) pair of horizontal feed rollers 57 is configured to be able to release nipping of a cover sheet P2.

The encoder 58 is disposed at the second-uppermost pair of upper rollers 52, and outputs a pulse signal according to rotations of the second-uppermost pair of upper rollers 52. The encoder 59 is disposed at the lowermost pair of lower rollers 53, and outputs a pulse signal according to rotations of the lowermost pair of lower rollers 53.

The sheet sensor 60 detects the sheet P fed along an upper section of the vertical feed path RV. The sheet sensor 60 is disposed between the uppermost pair of the upper rollers 52 and the second uppermost pair of upper rollers 52. The sheet sensor 60 is used for detecting a size of the cover sheet P2 fed along the vertical feed path RV.

The sheet sensor 61 detects the cover sheet P2 fed along a lower section of the vertical feed path RV. The sheet sensor 61 is disposed nearby the uppermost pair of the lower rollers 53. The sheet sensor 61 is used for aligning the cover sheet P2 when cutting the cover sheet P2 by the cutting unit 44.

The sheet sensor 62 detects the text-block sheets P1 to be fed out to the aligning unit 42. The sheet sensor 62 is disposed at an upstream side of the pair of the feed out rollers 55 and nearby the pair of the feed out rollers 55.

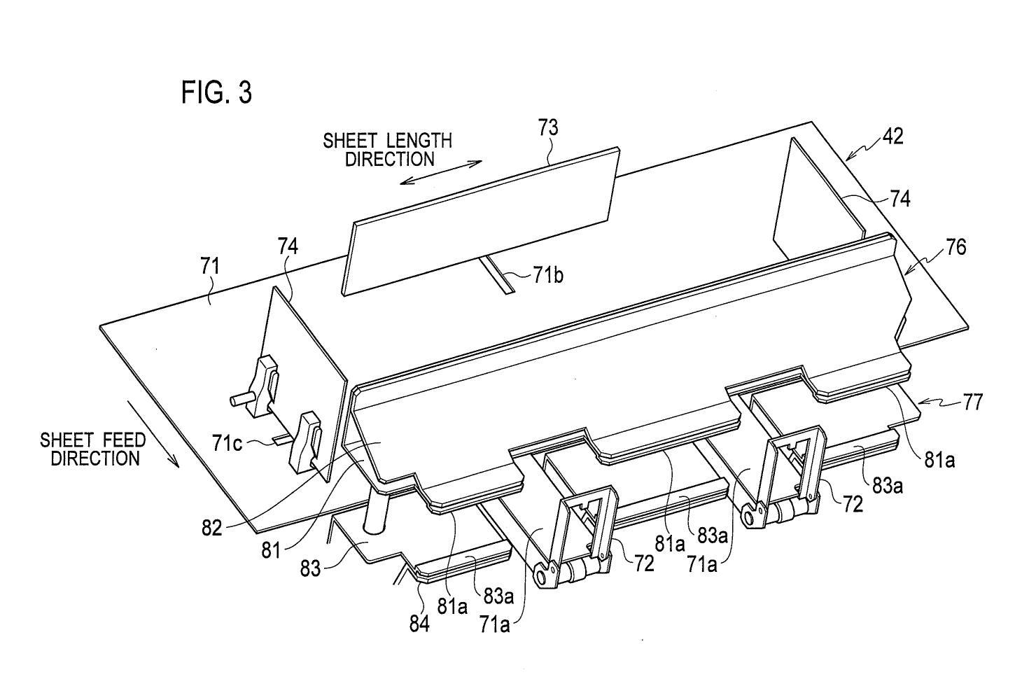

The aligning unit 42 aligns the printed text-block sheets P1. The aligning unit 42 is disposed at a downstream end of the text-block sheet feed out path RH. As shown in FIG. 3, the aligning unit 42 includes a sheet tray 71, two reference panels 72, an end fence 73, and a pair of side fences 74.

The sheet tray 71 receives the text-block sheets P1 sequentially fed out from the pair of feed out rollers 55 and fallen downward. The sheet tray 71 has two arms 71a that can be extended downstream along the sheet feed direction. In addition, on the sheet tray 71, a guide groove 71b for guiding the end fence 73 and guide grooves 71c for guiding the side fences 74 are formed. Note that the sheet feed direction in FIG. 3 is a direction in which the text-block sheets P1 are fed out from the pair of feed out rollers 55, and corresponds to a lower right direction in FIG. 1. In addition, a sheet width direction shown in FIG. 3 is parallel to a long side of the text-block sheet(s) P1 fed out onto the sheet tray 71, and corresponds to a direction orthogonal to a drawing surface of FIG. 1 (i.e. a front-back direction).

The reference plates 72 regulate, along the sheet feed direction, leading edges of the text-block sheets P1 stacked on the sheet tray 71. The reference plates 72 are extended upward from lower ends of the arms 71a, respectively. The reference plates 72 can be inclined to a downstream side of the sheet feed direction by motors (not shown).

The end fence 73 is provided for aligning, together with the reference plates 72, positions of the text-block sheets P1 stacked on the sheet tray 71 along the sheet feed direction (sheet width direction). The end fence 73 is configured to be slidable in the sheet feed direction by a motor (not shown). The end fence 73 slides while being guided by the guide groove 71b.

The pair of side fences 74 is provided for aligning positions of the text-block sheets P1 stacked on the sheet tray 71 along a sheet length direction. The pair of side fences 74 is configured to be slidable in the sheet length direction by a motor (not shown). The pair of side fences 74 slides so as to be distanced away from each other or to be approached to each other while being guided by the guide grooves 71c, respectively.

The clamper 43 clamps a sheet stack (paper stack) PS composed of the text-block sheets P1 stacked on the sheet tray 71 of the aligning unit 42 along a stacking direction (thickness/height direction) of the sheet stack PS to carry the sheet stack PS out from the aligning unit 42. The clamper 43 includes an upper clamp member 76 and a lower clamp member 77.

The upper clamp member 76 and the lower clamp member 77 are connected with a rotary shaft 79 by connection rods 78 as shown in FIG. 1. The upper clamp member 76 and the lower clamp member 77 can be moved, by a rotation of the rotary shaft 79, between a waiting position indicated by solid lines in FIG. 1 and a clamping position indicated by dashed two-dotted lines in FIG. 1. The waiting position is a position located above the binding unit 46. The clamping position is a position for clamping the sheet stack PS on the sheet tray 71 of the aligning unit 42 along the stacking direction of the text-block sheets PS in the sheet stack PS. In addition, the rotary shaft 79 is movable laterally (in a right-left direction) and vertically (in an upper-lower direction). Therefore, the sheet stack PS clamped by the upper clamp member 76 and the lower clamp member 77 can be moved to the gluing unit 45 and so on.

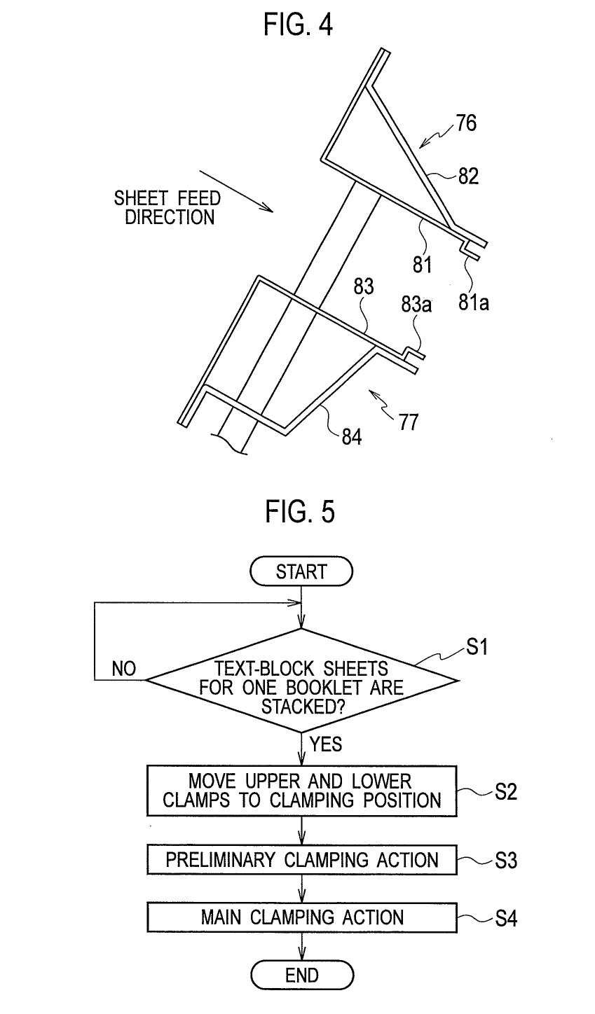

As shown in FIG. 3 and FIG. 4, the upper clamp member 76 and the lower clamp member 77 are provided so as to face each other. Note that FIG. 3 and FIG. 4 show a state where the upper clamp member 76 and the lower clamp member 77 are located at the clamping position, and the aligning unit 42 is not shown in FIG. 4.

The upper clamp member 76 includes a clamp plate 81 and a reinforcing plate 82. The clamp plate 81 clamps the sheet stack PS together with a clamp plate 83 of the lower clamp member 77. The clamp plate 81 is reinforced by the reinforcing plate 82. Three stepped edges 81a extending in the sheet length direction are formed along a downstream end of the clamp plate 81. The stepped edges 81a are bent inward to a side of the lower clamp member 77. The stepped edges 81a hold a sheet stack PS together with stepped edges 83a of the lower clamp member 77. As shown in FIG. 3, three of the stepped edges 81a are formed along the sheet length direction so as to be distanced away from each other and so as to avoid the arms 71a of the sheet tray 71. The upper clamp member 76 can slide so as to be distanced away from the lower clamp member 77 or to be approached to the lower clamp member 77.

The lower clamp member 77 includes a clamp plate 83 and a reinforcing plate 84. The clamp plate 83 clamps the sheet stack PS together with the clamp plate 81 of the upper clamp member 76. The clamp plate 83 is reinforced by the reinforcing plate 84. Three stepped edges 83a are formed along a downstream end of the clamp plate 83 so as to facing to the stepped edges 81a of the upper clamp member 76, respectively. The stepped edges 83a are bent inward to a side of the upper clamp member 76. At the clamping position, the lower clamp member 77 is located so as to contact the stepped edges 83a with a bottom surface of the sheet stack PS on the sheet tray 71.

In addition, the clamper 43 includes a sheet stack thickness sensor 86. The sheet stack thickness sensor 86 detects a thickness (height) of the sheet stack PS clamped by the upper clamp member 76 and the lower clamp member 77.

As shown in FIG. 2, the clamper 43 includes an open/close motor 87, a rotation motor 88, a lateral motion motor 89, and a vertical motion motor 90. The open/close motor moves the upper clamp member 76 and the lower clamp member 77 so as to make them distanced from each other or to make them approached to each other. The rotation motor 88 rotates the rotary shaft 79. The lateral motion motor 89 moves the rotary shaft 79 laterally (in the right-left direction). The vertical motion motor 90 moves the rotary shaft 79 vertically (in the upper-lower direction).

The cutting unit 44 cuts the cover sheet P2 to adjust a size of the cover sheet P2. The cutting unit 44 is disposed at a lower end of the vertical feed path RV.

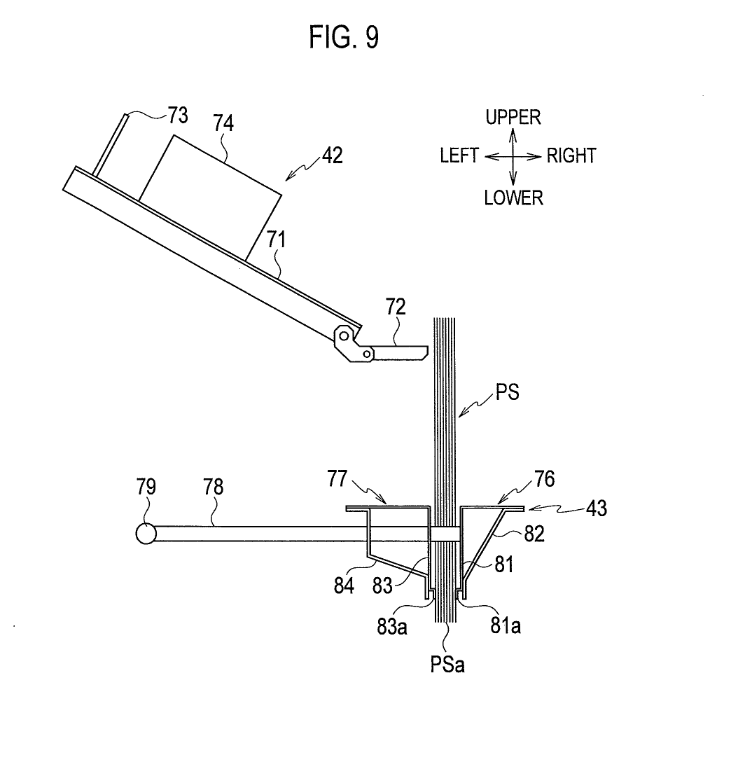

The gluing unit 45 pastes hot-melt adhesives G on a side PSa (see FIG. 9) of a sheet stack PS. The gluing unit 45 is disposed on a right side of the binding unit 46. The gluing unit 45 includes an adhesive tank 91, and a pasting roller 92.

The adhesive tank 91 accumulates the hot-melt adhesives G. The hot-melt adhesives G glue the sheet stack PS with the cover sheet P2.

The hot-melt adhesives G accumulated in the adhesive tank 91 are applied to an outer circumferential surface of the pasting roller 92, and then pasted on the side PSa of the sheet stack PS by contacting the pasting roller 92 with the side PSa of the sheet stack PS. The pasting roller 92 is configured to be rotatable by a motor (not shown). Therefore, a portion of the outer circumferential surface to which the hot-melt adhesives G are applied can be exposed.

The binding unit 46 makes a booklet B by covering the sheet stack PS by the cover sheet P2. The binding unit 46 is disposed on a downstream side from the pairs of horizontal feed rollers 57. The binding unit 46 includes a pair of covering plates 93 and a base plate 94.

The pair of covering plates 93 bends the cover sheet P2 at its borders between a spine and front/back faces. The pair of covering plates 93 is configured to be distanced away from each other or to be approached to each other by a motor (not shown). The pair of covering plates 93 is disposed on the base plate 94.

The side PSa of the sheet stack PS is contacted onto the base plate 94 with the cover sheet P2 interposed therebetween.

The ejection unit 47 ejects a booklet(s) B out from the housing 49. The ejection unit 47 is disposed at a lower portion in the housing 49. The ejection unit 47 includes a guide member 96, a feed conveyor 97, and an ejection conveyor 98.

The guide member 96 guides the booklet B made at the binding unit 46 and then fallen from a right side of the binding unit 46 so as to send the booklet B to the feed conveyor 97.

The feed conveyor 97 receives the booklet B from the guide member 96, and then feeds the booklet B leftward to fall it down to the ejection conveyor 98. The feed conveyor 97 is driven by a motor (not shown).

The ejection conveyor 98 receives the booklet B from the feed conveyor 97, and then feeds the booklet B rightward to fall it down to a receiving table (not shown) outside the housing 49. The ejection conveyor 98 is driven by a motor (not shown).

The binding controller 48 controls operations of the components of the binding machine 3. The binding controller 48 is configured to include a CPU, a RAM, a RAM, a HDD, and so on.

First, printing operations in the printer 2 will be explained. Here, text-block sheets P1 are stacked on the uppermost internal sheet supply tray 23, and cover sheets P2 are stacked on the external sheet supply tray 21.

When the printer 2 starts the printing operations, text-block sheets P1 that are not yet printed and fed along the sheet supply path RS from the uppermost internal sheet supply tray 23 are sequentially supplied to the print unit 12. In the print unit 12, the text-block sheet(s) P1 is fed to the belt feed unit 27 by the pair of registry rollers 26. Then, the text-block sheet P1 is printed by ink droplets injected from the inkjet unit 28 while it is fed by the belt feed unit 27.

In a case of single-side printing, the text-block sheet P1 whose one side has been printed is led to the transfer path RJ by the switching flap 29 of the transfer section 13 while it is fed by the belt feed unit 27. Then, the text-block sheet P1 is fed to the binding machine 3 by the pair of transfer rollers 30.

In a case of duplex printing, the text-block sheet P1 whose one side has been printed is led to the turn around section 14 by the switching flap 29 of the transfer section 13 while it is fed by the belt feed unit 27. The text-block sheet P1 is fed forward by the pairs of turn around rollers 31 of the turn around section 14, and then fed to the switchback path RR by the switching flap 32 of the ejection section 15. In the switchback section 16, the text-block sheet P1 is fed to the pair of switchback rollers 35 by the switching gate 38, and then inserted into the switchback space 36 by the pair of switchback rollers 35. Then, the text-block sheet P1 is fed out from the switchback space 36 by the pair of switchback rollers 35, and fed to the pair of re-supply rollers 37 by the switching gate 38. Subsequently, the text-block sheet P1 is supplied to the print unit 12 again by the pair of re-supply rollers 37. In the print unit 12, the text-block sheet P1 is fed to the belt feed unit 27 by the pair of registry rollers 26. Here, since the text-block sheet P1 was already turned over by the switchback section 16, its unprinted side is faced to the inkjet unit 28. The unprinted side of the text-block sheet P1 is printed by ink droplets injected from the inkjet unit 28 while it is fed by the belt feed unit 27. The text-block sheet P1 whose both sides has been printed is led to the transfer path RJ by the switching flap 29 of the transfer section 13 while it is fed by the belt feed unit 27. Then, the text-block sheet P1 is fed to the binding machine 3 by the pair of transfer rollers 30.

In the printing operations, plural text-block sheets P1 for a single booklet B are sequentially printed, and then a cover sheet P2 is printed. The cover sheet P2 is supplied from the external sheet supply tray 21, and then its one side or both sides are printed similarly to the above-explained case of the text-block sheet P1. Subsequently, the printed cover sheet P2 is led to the transfer path RJ by the switching flap 29 of the transfer section 13 while it is fed by the belt feed unit 27. Then, the cover sheet P2 is fed to the binding machine 3 by the pair of transfer rollers 30.

Next, binding operations in the binding machine 3 will be explained.

The text-block sheet(s) P1 printed by the printer 2 is introduced into the binding machine 3 by the pair of introduction rollers 51, and then fed upward by the pairs of upper rollers 52. Then, the text-block sheet P1 is fed to the text-block feed out path RH by the switching flap 54, and fed out to the aligning unit 42 by the pair of feed out rollers 55. The text-block sheet P1 falls down onto the sheet tray 71 from the pair of feed out rollers 55. Each time when one text-block sheet P1 falls, the end fence 73 and the pair of side fences 74 carry out a jogging action to aligning the text-block sheets P1 stacked on the sheet tray 71. When the text-block sheets P1 required for a single booklet B have been stacked on the sheet tray 71, the clamper 43 clamps a sheet stack PS composed of the text-block sheets P1 for a single booklet B.

Here, clamping operations of the sheet stack PS by the clamper 43 will be explained. FIG. 5 is a flowchart of the clamping operation.

When the printing operations are started in the printer 2, the binding controller 48 judges whether or not the text-block sheets P1 required for a single booklet B are stacked on the sheet tray 71 (step S1). Specifically, the binding controller 48 counts the number of the text-block sheets P1 detected by the sheet sensor 62, and determines that the text-block sheets P1 required for a single booklet B are stacked on the sheet tray 71 when the counted value reaches the number of sheets required for a single booklet B.

When it is determined that the text-block sheets P1 required for a single booklet B are not stacked on the sheet tray 71 (NO in step S1), the binding controller 48 repeats a process of the step S1.

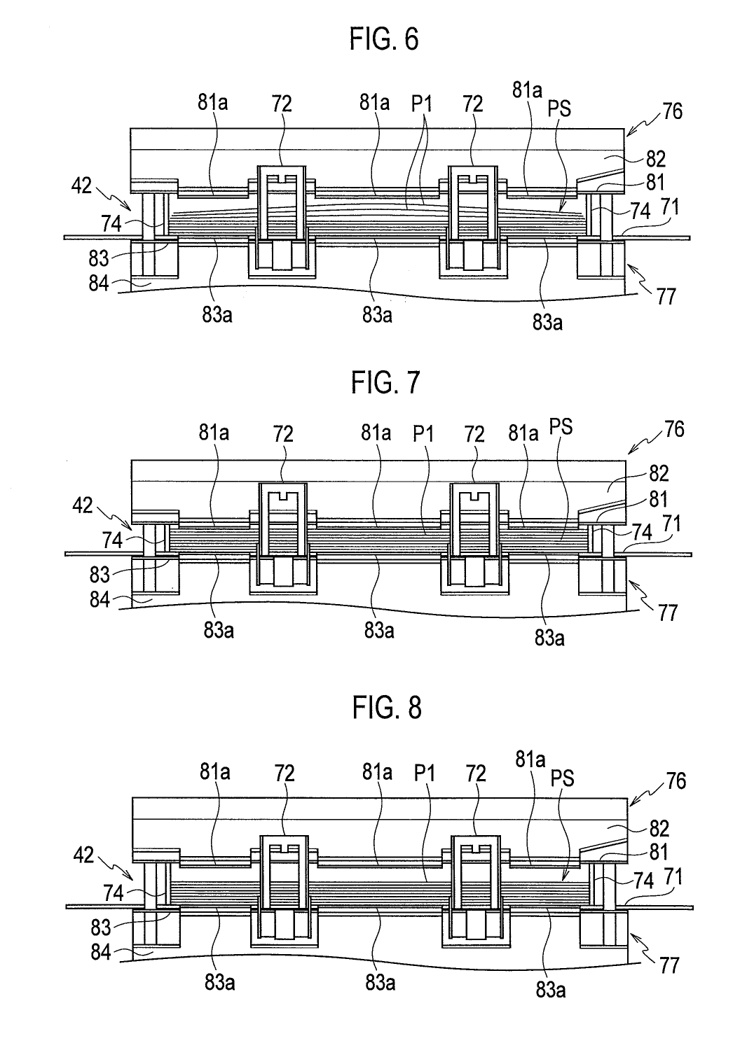

On the other hand, when it is determined that the text-block sheets P1 required for a single booklet B are stacked on the sheet tray 71 (YES in step S1), the binding controller 48 moves the upper clamp member 76 and the lower clamp member 77 to the clamping position as shown in FIG. 6 (step S2). Note that FIG. 6 shows a state, viewed from a downstream side along the sheet feed direction (from a lower right side in FIG. 1), where the text-block sheets P1 are stacked on the sheet tray 71 of the aligning unit 42 and the upper clamp member 76 and the lower clamp member 77 are located at the clamping position. In such a state, the sheet stack PS composed of the text-block sheets P1 may be curved upward due to air remaining between the text-block sheets P1 as shown in FIG. 6. Such upward curvatures tend to occur when thin papers (lightweight papers) are used as the text-block sheets P1.

Subsequently, the binding controller 48 controls the clamper 43 to execute a preliminary clamping action (step S3). In the preliminary clamping action, the upper clamp member 76 and the lower clamp member 77 clamp the sheet stack PS temporarily before an after-explained main clamping action.

Specifically, the binding controller 48 makes the upper clamp member 76 approached to the lower clamp member 77 to clamp the sheet stack PS between the stepped edges 81a of the upper clamp member 76 and the stepped edges 83a of the lower clamp member 77 as shown in FIG. 7. Then, the binding controller 48 makes the upper clamp member 76 distanced away from the lower clamp member 77 to release clamping as shown in FIG. 8. In this manner, the preliminary clamping action is finished.

In a case where the sheet stack PS is curved upward due to air remaining between the text-block sheets P1, the air is evacuated by the preliminary clamping action. At this time, winkles may occur at portions near areas pressed by the stepped edges 81a and 83a in the text-block sheets P1. However, when the preliminary clamping action is finished, the winkles in the text-block sheets P1 may disappear and the text-block sheets P1 become appressed to each other. Since the text-block sheets P1 become appressed to each other, the text-block sheets P1 are not lifted up by the upper clamp member 76 moved upward when clamping is released.

Subsequently, the binding controller 48 controls the clamper 43 to execute a main clamping action (step S4). In the main clamping action, the upper clamp member 76 and the lower clamp member 77 clamp the sheet stack PS conclusively in order to carry the sheet stack PS out from the aligning unit 42

Specifically, the binding controller 48 makes the upper clamp member 76 approached to the lower clamp member 77 to clamp the sheet stack PS between the stepped edges 81a of the upper clamp member 76 and the stepped edges 83a of the lower clamp member 77. In the sheet stack PS, the air between the text-block sheets P1 is evacuated by the preliminary clamping action in the step S3, and thereby the text-block sheets P1 are appressed to each other. Therefore, winkles in the text-block sheets P1 don't appear by the main clamping action.

As explained above, the clamping operations are finished. As a result, the upper clamp member 76 and the lower clamp member 77 clamp the sheet stack PS at the clamping position. And then, the binding controller 48 carries the sheet stack PS out from the aligning unit 42.

Specifically, the binding controller 48 controls the pair of reference plates 72 of the aligning unit 42 to incline the pair of reference plates 72 to a downstream side along the sheet feed direction. Subsequently, the binding controller 48 moves the upper clamp member 76 and the lower clamp member 77 that clamp the sheet stack PS from the clamping position to the waiting position as shown in FIG. 9 by rotating the rotary shaft 79.

On the other hand, the cover sheet P2 printed by the printer 2 is introduced into the binding machine 3 by the pair of introduction rollers 51, and then fed upward by the pairs of upper rollers 52. At this time, the cover sheet P2 is detected by the sheet sensor 60.

Here, the binding controller 48 measures a length of the cover sheet P2 along the sheet feed direction based on the number of pulses output from the encoder 58 from a time when a leading edge of the cover sheet P2 is detected to a time when a trailing edge of the cover sheet P2 is detected. Then, the binding controller 48 calculates a cut length of the cover sheet P2 by subtracting a required size (length) according to the thickness of the sheet stack PS from the measured length of the cover sheet P2. The required size is a length obtained by adding the thickness of the sheet stack PS to twice the width of the text-block sheet P1. The binding controller 48 retrieves the thickness of the sheet stack PS from the sheet stack thickness sensor 86 when the clamper 43 clamps the sheet stack PS.

After the trailing edge of the cover sheet P2 is detected by the sheet sensor 60, the binding controller 48 drives the pairs of upper rollers 52 reversely. Then, the cover sheet P2 is fed downward by the pairs of upper rollers 52 and the pairs of lower rollers 53.

At a time when a leading edge (lower edge) of the cover sheet P2 reaches a lower position lower from a cut position of the cutting unit 44 by the cut length, the binding controller 48 stops the pairs of upper rollers 52 and the pairs of lower rollers 53. Specifically, the binding controller 48 starts counting the number of pulses of the encoder at a time when the sheet sensor 61 detects the leading edge (lower edge) of the cover sheet P2. Then, the binding controller 48 stops the pairs of upper rollers 52 and the pairs of lower rollers 53 at the time when the counted value reaches a value corresponding to a total length of a vertical distance between the sheet sensor 61 and the cut position of the cutting unit 44 and the above-explained cut length. Subsequently, the binding controller 48 controls the cutting unit 44 to cut the cover sheet P2.

The cut cover sheet P2 is fed upward by the pairs of upper rollers 52 and the pairs of lower rollers 53. After a cut trailing edge (lower edge) of the cover sheet P2 passes over the branch point of the vertical feed path RV and the cover sheet set path RF, the cover sheet P2 is fed downward reversely by the pairs of upper rollers 52. The cover sheet P2 is fed to the cover sheet set path RF by the switching flap 56, and then laid on the pair of the covering plates 93.

After the cover sheet P2 is laid on the pair of the covering plates 93, the binding controller 48 moves the upper clamp member 76 and the lower clamp member 77 that clamp the sheet stack PS from the waiting position to a position above the gluing unit 45 by moving the rotary shaft 79 laterally. Then, the binding controller 48 moves the upper clamp member 76 and the lower clamp member 77 downward by moving the rotary shaft 79 downward by moving the rotary shaft 79 downward to contact the (bottom) side PSa of the sheet stack PS with the pasting roller 92. Therefore, hot-melt adhesives G are pasted on the side PSa of the sheet stack PS.

Subsequently, the binding controller 48 brings the upper clamp member 76 and the lower clamp member 77 that clamp the sheet stack PS back to the waiting position. Then, the binding controller 48 moves the upper clamp member 76 and the lower clamp member 77 downward to press the side PSa of the sheet stack PS onto the base plate 94 with the cover sheet P2 interposed therebetween.

Subsequently, the binding controller 48 moves the pair of covering plates 93 to approach them to each other. A lower portion of the sheet stack PS is pressed by the pair of covering plates 93 with the cover sheet P2 interposed therebetween. By this action, the cover sheet P2 is bent at the borders between a spine and front/back face. As a result, a booklet B is made.

When the booklet B is made, the binding controller 48 moves the upper clamp member 76 and the lower clamp member 77 that clamp the sheet stack PS to a right side of the binding unit 46, and then release the booklet B by unclamp the clamper 43 (the upper clamp member 76 and the lower clamp member 77). As a result, the booklet B is falls down to the feed conveyor 97 while guided by the guide member 96.

The booklet B fallen onto the feed conveyor 97 is fed leftward by the feed conveyor 97, and then falls down onto the ejection conveyor 98. Subsequently, the booklet B is fed rightward by the ejection conveyor 98, and then ejected to the receiving table (not shown) outside the housing 49. In this manner, the binding operations are finished.

As explained above, when clamping the sheet stack PS by the clamper 43 in the binding machine 3, the preliminary clamping action is executed before the main clamping action.

The clamper 43 of the binding machine 3 is not a device for clamping entire both surfaces of a sheet stack PS, but a device for clamping portions of a sheet stack PS by the stepped edges 81a of the upper clamp member 76 and the stepped edges 83a of the lower clamp member 77. Therefore, in a case where a sheet stack PS is curved upward due to air remaining between text-block sheets P1, winkles may occur at portions near areas pressed by the stepped edges 81a and 83a in the text-block sheets P1 when the sheet stack PS is clamped between the stepped edges 81a of the upper clamp member 76 and the stepped edges 83a of the lower clamp member 77. If a booklet B is made, differently from the above-explained embodiment, by pasting hot-melt adhesives G on a side of a sheet stack PS clamped by only a single clamping action, the booklet B may have winkles in the text-block sheets P1.

However, according to the present embodiment, even in a case where a sheet stack PS is curved upward due to air remaining between text-block sheets P1, the air remaining between the text-block sheets P1 is evacuated by the preliminary clamping action, and thereby the text-block sheets P1 can be appressed to each other. Therefore, although the following main clamping action is an action for clamping plural portions of a sheet stack PS, winkles in the text-block sheets P1 can be restricted when the sheet stack PS is clamped by the main clamping action. As a result, the booklet B having winkles in the text-block sheets P1 can be prevented from being made.

In addition, since the text-block sheets P1 are made appressed to each other by the preliminary clamping action, misalignments of the text-block sheets P1 in the sheet stack PS can be also prevented when the sheet stack PS is clamped by the main clamping action. Therefore, unevenness of the hot-melt adhesives G pasted on the side PSa of the sheet stack PS can be prevented, and thereby missing of pages in a booklet B can be prevented.

In the above embodiment, the preliminary clamping action is executed only once. However, two or more of the preliminary clamping actions may be executed. Note that, in the above binding machine 3, the binding controller 48 can also execute the binding operations without the preliminary clamping action. In addition, the number of times of the plural preliminary clamping actions may be determined based on a type of text-block sheets P1.

As a type of text-block sheets P1, there are thin papers (lightweight papers), plain papers (regular papers), heavy papers, and so on. The thinner (lighter) every text-block sheet P1 is, the more air remains between the text-block sheets P1 in the sheet stack PS. Therefore, the thinner (lighter) every text-block sheet P1 is, the more times the preliminary clamping actions may be executed. In addition, if text-block sheets P1 are heavy papers, the binding controller 48 can omit the preliminary clamping action. By these operations, air remaining between text-block sheets P1 can be evacuated surely by the adequate numbers of times of the preliminary clamping actions according to a type of the text -block sheets P1.

In addition, the number of times of the preliminary clamping actions may be determined based on a size of text-block sheets P1. The larger a size of text-block sheets P1 is, the more air remains between the text-block sheets P1 in the sheet stack PS. Therefore, the larger a size of text-block sheets P1 is, the more times the preliminary clamping actions may be executed. By this operation, air remaining between text-block sheets P1 can be evacuated surely by the adequate numbers of times of the preliminary clamping actions according to a size of the text-block sheets P1.

Further, the number of times of the preliminary clamping actions may be determined based on a thickness (height) of a sheet stack PS. The thicker (higher) a sheet stack PS is, the more difficultly air evacuates from the sheet stack PS. Therefore, the thicker (higher) a sheet stack PS is, the more times the preliminary clamping actions may be executed. By this operation, air remaining between text-block sheets P1 in a sheet stack PS can be evacuated surely by the adequate numbers of times of the preliminary clamping actions according to a thickness of the sheet stack PS.

Further, the number of times of the preliminary clamping actions may be determined based on a combination of two or more of a type of text-block sheets P1, a size of text-block sheets P1, and a thickness (height) of a sheet stack PS.

When the plural preliminary clamping actions are executed, the second and later preliminary clamping actions may be executed faster than the first preliminary clamping action. By this operation, productivity decline of booklets B can be prevented. It is preferable to execute the first preliminary clamping action at a relatively slow speed in order to evacuate air while preventing misalignments of the text-block sheets P1.

The present invention is not limited to the above-mentioned embodiment, and it is possible to embody the present invention by modifying its components in a range that does not depart from the scope thereof. Further, it is possible to form various kinds of inventions by appropriately combining a plurality of components disclosed in the above-mentioned embodiment. For example, it may be possible to omit several components from all of the components shown in the above-mentioned embodiment.

The present application claims the benefit of a priority under 35 U.S.C. §119 to Japanese Patent Application No. 2013-71307, filed on Mar. 29, 2013, the entire content of which is incorporated herein by reference.

What is claimed is:

1. A sheet stack clamping device comprising:
a clamper for clamping a sheet stack composed of plural sheets stacked on a sheet tray along a stacking direction; and
a controller that executes a preliminary clamping action for clamping the sheet stack temporarily by the clamper at least once before executing a main clamping action for clamping the sheet stack conclusively by the clamper.

2. The sheet stack clamping device according to claim 1, wherein,
the controller determines the number of times of the preliminary clamping actions based on at least one of a type of sheets in the sheet stack, a size of sheets in the sheet stack, and a thickness of the sheet stack.
